(19) United States
(12) Patent Application Publication
(10) Pub. No.: US 2019/0387258 A1
(43) Pub. Date: Dec. 19, 2019

(54) MULTI-CAST MEDIA PLAYER SYSTEM FOR ENCRYPTED ON-SITE IPTV DISTRIBUTION

(71) Applicants: Brian Cunningham, San Clemente, CA (US); Orion Doty, Colorado Springs, CO (US); Darren King, Malmesbury (GB)

(72) Inventors: Brian Cunningham, San Clemente, CA (US); Orion Doty, Colorado Springs, CO (US); Darren King, Malmesbury (GB)

(73) Assignee: ROOMNETTV LLC., San Clemente, CA (US)

(21) Appl. No.: 16/444,878

(22) Filed: Jun. 18, 2019

Related U.S. Application Data
(60) Provisional application No. 62/686,596, filed on Jun. 18, 2018.

(51) Int. Cl. H04N 21/2347; H04N 21/4363; H04N 21/6405; H04N 21/643

(52) U.S. Cl. CPC H04N 21/2347; H04N 21/64322; H04N 21/6405; H04N 21/43635

(57) ABSTRACT

A multi-cast IPTV software solution for AppleTV™ devices is described. The solution employs industry standard Pro:Idiom-M encryption to satisfy content distribution contracts to the hospitality industry of the United States from prominent media companies in a unique manner not previously accomplished by conventional IPTV service software applications. Per the multi-cast setup afforded to hotels, hospitals, and other agents of the hospitality industry, users are able to simultaneously view programming throughout the network without substantial loss of bandwidth, and while maintaining the protections afforded by encryption as mandated by most US content providers. The software solution ensures comprehensive compatibility between an AppleTV running tvOS and encrypted IPTV streams.

### CONTINUITY

This application is a non-provisional patent application of provisional patent application No. 62/686,596, filed on Jun. 18, 2018, and priority is claimed thereto.

### FIELD OF THE PRESENT INVENTION

The present invention relates to the field of media distribution, and more specifically relates to a system for playing multi-cast media via a software application configured to enable the playback of live TV content delivered to a TV-connected device employed in the hospitality industry via IPTV distribution.

### BACKGROUND OF THE PRESENT INVENTION

Historically, hotels have been conventionally equipped with entertainment systems configured to distribute live TV to rooms via coaxial cabling. The use of distributed set-top boxes is historically commonplace. However, as the entertainment industry moves closer to network-based distribution systems, IPTV and multi-cast arrangements are becoming more common. Despite this progression, few hospitality venues have ventured to provide such services via app-based IPTV-enabled set-top boxes such as AppleTV™ or similar TV-connected computer devices. Such IPTV systems would enable a hospitality proprietor to convey media services to each room while maintaining adequate bandwidth throughout the network.

Due to industry precautions against copyright infringement, media conveyed from prominent media distributors, such as cable companies and streaming services, require such systems to be compliant with industry-accepted encryption protocols. In the United States, the presently employed encryption protocol/standard is that of Pro:Idiom hardware encryption. Unfortunately, the popular device AppleTV, manufactured by Apple™, has yet to provide an application compatible with Pro:Idiom hardware encryption for live television broadcast via IPTV.

Thus, there is a need for a new software solution that facilitates use of AppleTV in a hospitality setting while satisfying the Pro:Idiom-M encryption standard to facilitate playback of live TV and other media from popular distribution agents such as cable TV and satellite TV companies. As such cable TV and satellite TV companies employ Pro:Idiom-M encryption at the head end of content delivery, maintaining the Pro:Idiom-M encryption standard in end user distribution is critical in order to obtain content delivery contracts from such companies (DishTV™, DirecTV™, etc.).

By giving AppleTV (tvOS) and potentially iOS devices the capability to access multicast streams locally encrypted with Pro:Idiom-M, this solution benefits any multi-tenant venue through the ability to use AppleTV devices in lieu of a traditional set-top based TV solution.

Few other live TV players exist on the market for the purpose of delivering TV content to an AppleTV device over the Internet, however none of them employ the industry standard encryption protocols at the output of the AppleTV to facilitate on-prem or locally delivered content for use in the hospitality industry. Conversely, the software system of the present invention is the only application that currently provides for IPTV content delivery over multicast for tvOS. As an additional capability to that function, the present invention offers the only tvOS application that offers the Pro:Idiom-M software encryption implementation method for accessing local IPTV multicast streams. Compliance with this encryption protocol is mandatory for distributed programming in a hospitality setting, or any large, multi-room facility installation.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a software system for distribution and playback of multi-cast media streams via Apple™ TV devices. The system is configured for use in distributed IPTV systems, such as those conventionally found in the hospitality industry.

As such, the software application and system of the present invention has been purpose designed to provide on-premise live TV content ingestion and playback for any multi-tenanted venue where IPTV is delivered, such as hotels, hospitals, long-term stay facilities, dormitories, and similar public transient venues. Its proprietary functionality essentially provides AppleTV devices with a software application required to perform in these venues in lieu of a set-top (or set-back) appliance for multicast IPTV.

It is known that Pro:Idiom is traditionally a hardware encryption technology which requires a physical chipset in the TV or set-top box which is not something Apple™ offers or embeds within the AppleTV device. The software variant of this encryption, referenced as Pro:Idiom-M, which when combined with the CMS-driven video playback architecture of the present invention, provides the system of the present invention the ability to decrypt IP video streams within the context of AppleTV (tvOS) via the media player application of the present invention.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the process of use of the present invention as depicted from the viewpoint of the end user.

FIG. 2 depicts a basic flow chart of the layout of the IPTV network and decryption of the stream employed by the software solution of the present invention in a conventional installation.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a media content distribution platform configured for use on TV-connected hardware devices such as AppleTV running tvOS. As such, the present invention amounts to a proprietary software solution for IPTV multicast for use on AppleTV devices.

The system employs conventional Internet Group Management Protocol (IGMP) to facilitate IPTV multicast playback across a network. Such an arrangement is ideal for installations within the hospitality industry, including hotels, hospitals, long-term stay facilities, dormitories, and similar public transient venues. Conventionally, hotels and other centers of distributed media employ special televisions equipped with decoders compatible with the Pro:Idiom encryption protocol. Presently, without implementation of the present invention, these televisions are not capable of media playback of live TV streams via an AppleTV, as the TVos produced by Apple does not natively support Pro:Idiom encryption. As such, the AppleTV device could not accept a media feed pushing the Pro:Idiom encryption protocol on the frontend, nor could it output media encrypted with Pro:Idiom to a Pro:Idiom decrypting television.

With the advent of Pro:Idiom-M, the system of the present invention embeds the Pro:Idiom-M encryption protocol into a multi-cast application compatible with tvOS, facilitating the playback of encrypted and non-encrypted streams via an AppleTV system.

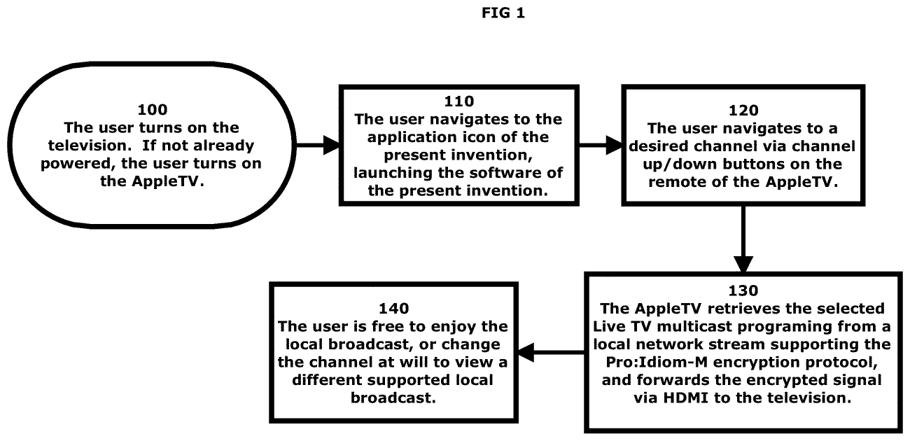

The process of use of the present invention by an end user, as depicted in FIG. 1, is preferably as follows:

1. The user turns on the television. If not already powered, the user turns on the AppleTV. (100)

2. The user navigates to the application icon of the present invention, launching the software of the present invention. (110)

3. The user navigates to a desired channel via channel up/down buttons on the remote of the AppleTV. (120)

4. The AppleTV retrieves the selected Live TV multicast programing from a local network stream supporting the Pro:Idiom-M encryption protocol, and forwards the encrypted signal via HDMI to the television. (130)

5. The user is free to enjoy the local broadcast, or change the channel at will to view a different supported local broadcast. (140)

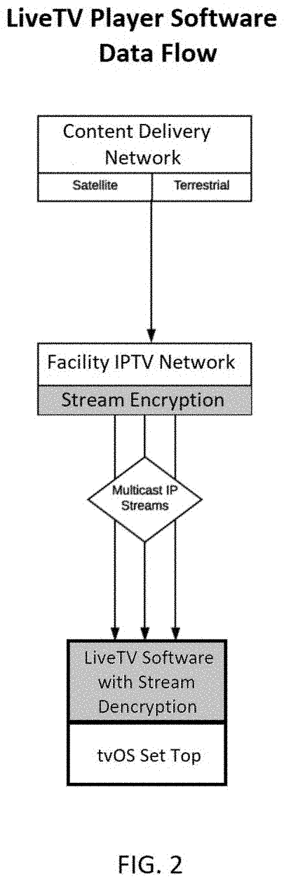

The backend process enacted by the software solution of the present invention is depicted in a basic flow chart in FIG. 2. In each installation, an AppleTV is connected to each television of a hotel or similar hospitality location by a proprietor. The AppleTV is connected to a hardwired ethernet connection of the location via a CAT6 cable or similar (CAT5, CAT5e), and to the television via an HDMI cable. As shown, each location is equipped with a multi-cast IPTV setup. The content delivery network may be from any provider, including satellite, terrestrial, or both.

In alternate embodiments of the present invention, it is envisioned that additional encryption support may be added for broader regional and global reach of the software solution of the present invention.

However, the underlying unique method claim to the invention (application), is that of the ingestion and playback of local multi-cast IPTV content streams on tvOS devices for both encrypted and un-encrypted streams. This method is not expected to change or take on other forms for the foreseeable future.

It should be understood that the present invention preferably requires 100 mbs broadband network connection service or higher in any given installation of the system of the present invention. Additionally, it should be understood that each television of the installation location is equipped with an independent AppleTV device running an up-to-date tvOS compatible with the application of the present invention.

In short, it should be understood that the approach of the present invention to access and playback of on-premise multicast live TV content streams over an tvOS (AppleTV) or iOS platform is entirely unique as it provides a unique software solution to TV viewing for the hospitality vertical.

Finally, it should be understood that the present invention is configured to offer a robust and highly evolved TV experience as a replacement solution for legacy TV technology in hotels and multi-tenant facilities.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A method of conveying live entertainment packages to multiple rooms of a hospitality location comprising:
connecting an IPTV streaming device to a hardwired ethernet connection via a CAT6 cable;
connecting a television to the IPTV streaming device via an HDMI cable;
configuring the IPTV streaming device to connect to local multi-cast IPTV content streams;
wherein the local multi-cast IPTV content streams are available as encrypted and un-encrypted streams;
subsequently placing additional IPTV streaming devices in additional rooms of the hospitality location; and
connecting the additional IPTV streaming devices to the hardwired ethernet connection.

2. The method of claim 1, wherein the IPTV streaming device is an AppleTV™.

3. The method of claim 2, wherein the local multi-cast IPTV content employs Pro:Idiom-M encryption protocol.
